(19) United States
(12) Patent Application Publication
(10) Pub. No.: US 2006/0139671 A1
(43) Pub. Date: Jun. 29, 2006

(54) Image forming apparatus and method of controlling apparatus

(75) Inventors: Takayuki Sadakuni, Numazu-shi (JP); Daisuke Murakoshi, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 11/023,803

(22) Filed: Dec. 27, 2004

(51) Int. Cl. G06K 15/00

(52) U.S. Cl. 358/1.13; 358/1.16

(57) ABSTRACT

Of the image data acquired by scanning a document and image data externally input, one or more image data mainly to be printed are stored in a hard disk drive, without being changed in format. Each image data item stored in the hard disk drive is edited and output, while remaining in the initial image format.

### BACKGROUND OF THE INVENTION

1. Field of the Invention

The present invention relates to an image forming apparatus of multi-function peripheral type, and to a method of controlling the apparatus.

2. Description of the Related Art

An image forming apparatus of multi-function peripheral (MFP) type is known. This apparatus performs not only the ordinary copying function, but also a scanning function, a facsimile function and the like.

The image forming apparatus of MFP type has a storage device such as a hard disk drive. The hard disk drive can store the image data that represents the image read by scanning a document, and the image data that has been input from an external apparatus such as a personal computer. The apparatus can edits image data stored in the hard disk drive and can print and output them as one document.

Image data acquired by scanning documents and image data input from external apparatuses are of various formats, such as TIFF, PDF and JPEG. These image data of different formats are converted to data of one versatile image format and then stored in the hard disk drive.

The images printed on the basis of the data stored in the hard disk drive may, in some cases, inferior in quality to the images printed on the basis of the data acquired by scanning documents.

In addition, the hard disk drive can store image data received in the form of facsimile data and E-mail data.

### BRIEF SUMMARY OF THE INVENTION

An object of the present invention is to provide an image forming apparatus that can always output prints of high image-quality, and a method of controlling the apparatus. Another object of the invention is to provide an image forming apparatus that can make an effective use of the image data stored in a storage device, and a method of controlling this apparatus.

An image forming apparatus according to an aspect of this invention comprises:

a storage device for storing image data acquired by scanning a document and image data externally input;

a control section which stores one or more of image data in the storage device, without changing the format of the image data, the one or more data being those that are mainly to be printed; and

an output section which outputs each of the image data stored in the storage device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram showing the outer appearance of each embodiment;

FIG. 2 is a diagram depicting the configuration of the control panel of each embodiment;

FIG. 3 is a block diagram showing the control circuit of each embodiment;

FIG. 4 is a flowchart explaining the operation of the first embodiment;

FIG. 5 is a diagram illustrating the data configuration in the hard disk drive incorporated in the first embodiment;

FIG. 6 is a diagram representing the property data relating to the document printing performed in the first embodiment;

FIG. 7 is a diagram representing the property data relating to the page printing performed in the first embodiment;

FIG. 8 is a flowchart explaining the operation of the second embodiment;

FIG. 9 is a diagram showing the setting screen for a destination, which is displayed in the second embodiment;

FIG. 10 is a diagram explaining an operation the user may perform on the setting screen shown in FIG. 9;

FIG. 11 is a diagram showing the confirmation menu that is displayed when the user finishes the operation shown in FIG. 10;

FIG. 12 is a diagram depicting an input menu that is displayed after the menu shown in FIG. 11; and

FIG. 13 is a diagram depicting an input menu that is displayed after the menu shown in FIG. 12.

### DETAILED DESCRIPTION OF THE INVENTION

[1] The first embodiment of the invention will be described, with reference to the accompanying drawings.

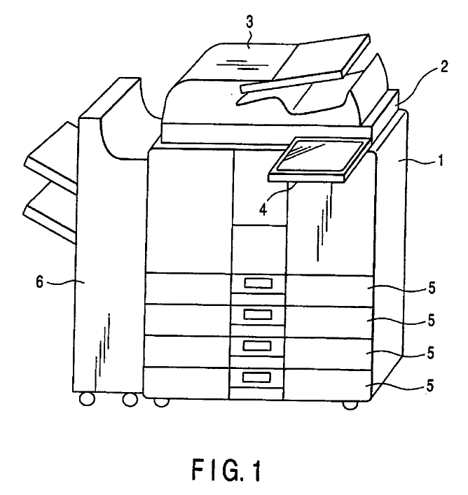

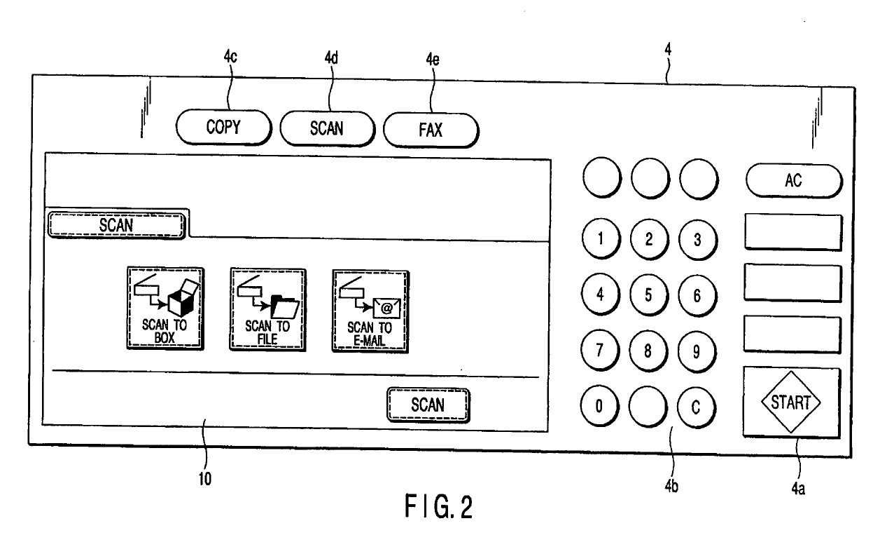

As FIG. 1 shows, an image forming apparatus has a main unit 1 and a document table 2 mounted on the top of the main unit 1. An automatic document feeder (ADF) 3 is provided on the document table 2 and can be opened and closed. At the same level as the document table 2, a control panel 4 is provided to function as operation means for setting operating conditions. As FIG. 2 shows, the control panel 4 has a start key 4a, a ten-key pad 4b, a copy key 4c, a scan key 4d, a facsimile key 4e, a liquid crystal display screen (i.e., display section) 10 of touch-panel type, and the like.

A plurality of cassettes 5 are provided in the lower part of the main unit 1. Each cassette 5 contains paper sheets of a specific size, which are image-forming media. A sheet-tray unit 6 is provided on one side of the main housing. The unit 6 receives printed paper sheets ejected from the main unit 1.

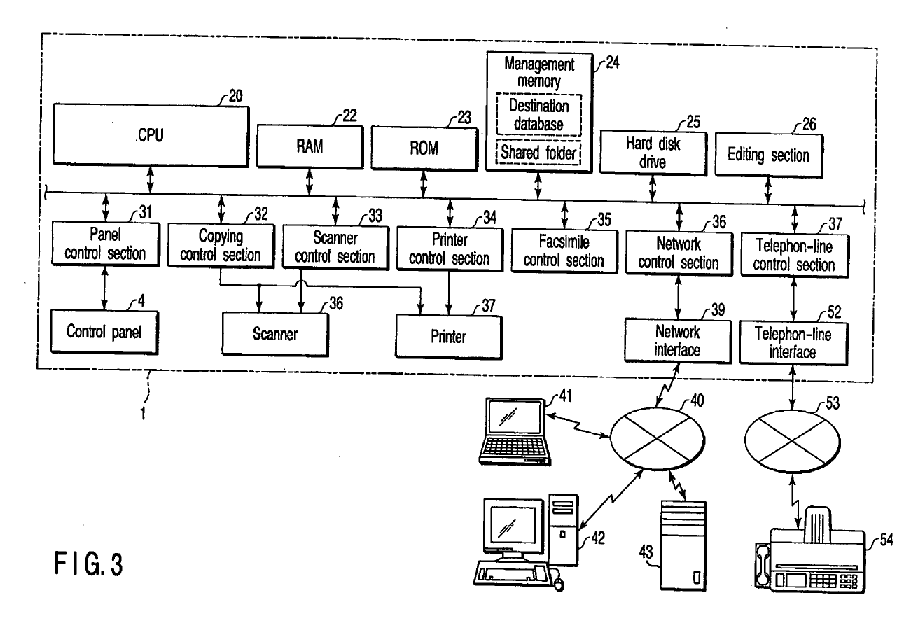

The main unit 1 incorporates a control circuit. FIG. 3 shows the control circuit and some external apparatuses.

The control circuit has a CPU 20 that is the main control unit. To the CPU 20 there are connected a RAM 22, a ROM 23, a management memory 24, i.e., nonvolatile memory, a storage device, e.g., a hard disk drive 25, an editing section 26, a panel control section 31, a copying control section 32, a scanner control section 33, a printer control section 34, a facsimile (Fax) control section 35, a network control section 38, and a telephone-line control section 37.

The RAM 22 is provided to store various data. The ROM 23 stores various control programs that are necessary to the main unit 1. The hard disk drive 25 stores image data. It is also known as “filing box”. The editing section 26 edits each image data item stored in the hard disk drive 25, maintaining the data item in its image format.

The panel control section 31 controls the control panel 4. The copying control section 32 controls the ordinary copying function accomplished by using a scanner 36 and a printer 37. The scanner control section 33 controls the scanning functions carried out by using the scanner 36. (The scanning functions include a scan-to-box function, scan-to-file function and scan-to-E-mail function.) The printer control section 34 controls the network print function achieved by using the printer 37.

The network control section 38 controls the data transfer with a communications network 40 via a network interface 39. External apparatuses, for example, personal computers 41 and 42, a server 43 and an image forming apparatus (MFP), are connected to the communications network 40.

The personal computers 41 and 42 and the server 43 have E-mail addresses specific to them, respectively.

The telephone-line control section 51 controls the communication with the public telephone line 53, via a telephone-line interface 52. The public telephone line 53 can connect the main unit 1 to a facsimile apparatus 54. A specific telephone number is assigned to the facsimile apparatus 54.

The facsimile control section 35 uses the network control section 38 and telephone-line control section 51, controlling facsimile transmission.

The CPU 20 has the following control sections (1) and (2), each performing a main function.

(1) The first control section that stores, in the hard disk drive 25, one or more image data to be printed, in the original format and jointly with the property data relating to the printing of the image data, said data having been selected from those acquired by scanning documents and input from external apparatuses.

(2) The second control section that converts one or more image data not mainly to be printed, to those of a prescribed versatile image format, and then stores them in the hard disk drive 25, jointly with the property data relating to the printing of the image data, said data having been selected from those acquired by scanning documents and input from external apparatuses.

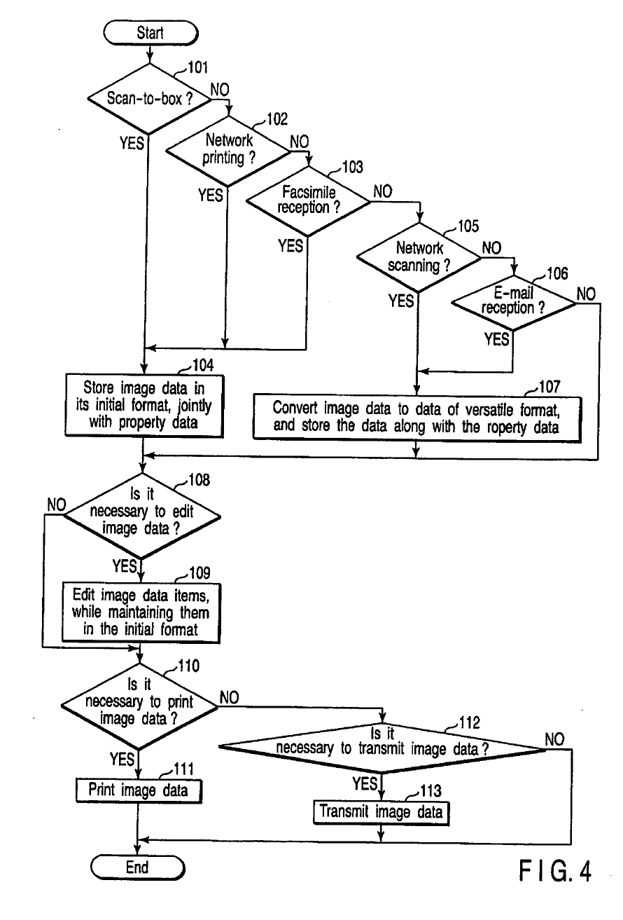

How the image forming apparatus operates will be explained, with reference to the flowchart of FIG. 4.

In the scan-to-box mode (YES in Step 101), the image data acquired by scanning a document can be stored in the hard disk drive 25. It is determined that the image data acquired by scanning the document is mainly to be printed. Therefore, the image data is stored, in its initial format, in the hard disk drive 25, jointly with the property data relating to the printing of the image data (Step 104). The property data is stored in association with the image data.

In the network-print mode (YES in Step 102), the image data transmitted via a communications network 40 can be printed on paper sheets. In this case, too, it is determined that the image data transmitted via the communications network 40 is mainly to be printed. Therefore, the image data is stored, in its initial format, in the hard disk drive 25, jointly with the property data relating to the printing of the image data (Step 104).

In the facsimile-reception mode (YES in Step 103), the facsimile image data transmitted through the public telephone line 53 can be printed on paper sheets. In this case, too, it is determined that the facsimile image data transmitted through the public telephone line 53 is mainly to be printed. Thus, the facsimile image data is stored, in its initial format, in the hard disk drive 25, jointly with the property data relating to the printing of the image data (Step 104).

Among the network-scan modes are scan-to-file mode and scan-to-E-mail mode. In the scan-to-file mode, the image data acquired by scanning a document is stored into, for example, the server 43 via the communications network 40. In the scan-to-E-mail mode, the image data acquired by scanning a document is attached to an E-mail, and the E-mail is sent to, for example, the personal computer 41 via the communications network 40.

In the network-scan mode (YES in Step 105), it is determined that the image data acquired by scanning the document is not mainly to be printed. Thus, the image data is converted data of a prescribed versatile image format (e.g., JPEG). The image data thus converted is stored in the hard disk drive 25, jointly with the property data relating to the printing of the image data (Step 107).

In the E-mail-reception mode (YES in Step 106), an E-mail (to which image data is attached) can be received through the communications network 40. It is determined that the image data attached to the E-mail transmitted through the public telephone line 53 is not mainly to be printed. Therefore, the facsimile image data is converted data of the prescribed versatile image format. The image data thus converted is stored in the hard disk drive 25, along with the property data relating to the printing of this image data (Step 107).

If necessary (YES in Step 108), the personal computers 41 and 42 connected to the apparatus by the communications network 40 to the image forming apparatus can edit the image data stored in the hard disk drive 25, into a single document (Step 109). While being so edited, each image data item stored in the hard disk drive 25 remains in the initial format.

If necessary (YES in Step 110), the printer 37 prints each image data edited (Step 111). Further, if necessary (YES in Step 112), each image data item edited is transmitted through the network control section 38 or the telephone-line interface 52 (Step 113).

The image data acquired by scanning a document or the image data input from an external apparatus may be of various formats, such as TIFF, PDF and JPEG. As described above, any image data that is mainly to be printed is stored in the hard disk drive 25, in its initial format, not converted to image data of another format.

Hence, the image represented by the image data read from the hard disk drive 25 or by the image data read from the hard disk drive 25 and then edited can be printed on the basis of the stored property data, in so high quality as the image printed by using the image data acquired by scanning a document.

FIG. 5 illustrates the data configuration in the hard disk drive 25. As seen from FIG. 5, the hard disk drive 25 stores a plurality of image files. Each image file contains the image data (one or more pages of image data) that pertains to one document. Each image file is associated with a document-print property file, which is managed for the image file.

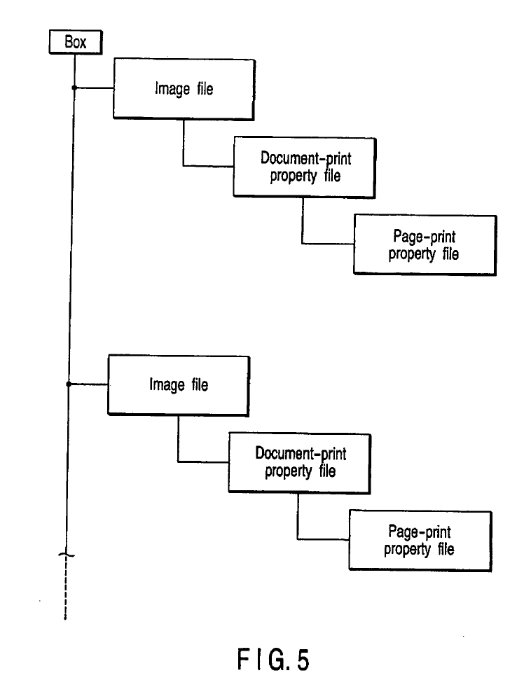

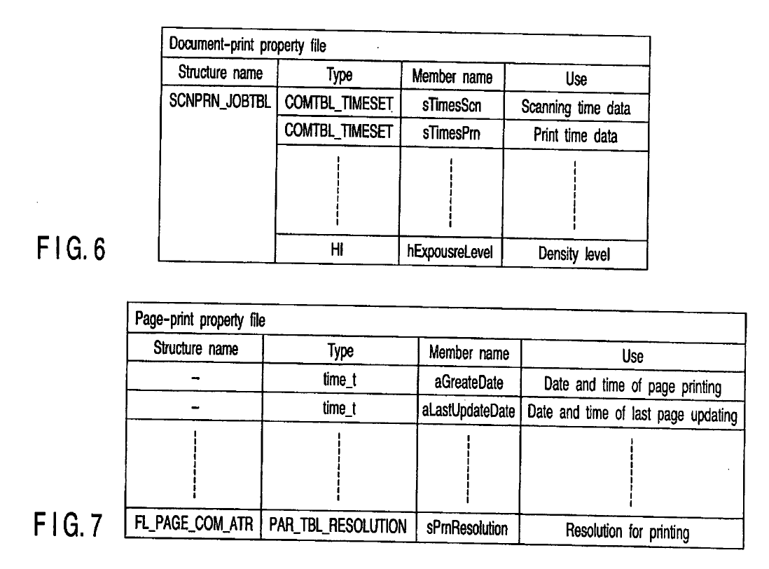

As FIG. 6 shows, the document-print property file contains a number of property data relating to the printing of the document. The document-print property file is associated with sub-property files, i.e., page-print property files, each pertaining to one page. As FIG. 7 depicts, each page-print property file contains a number of property data.

[2] The second embodiment of the invention will be described.

The second embodiment has a management memory 24, which stores a destination database and a shared folder.

External apparatuses, i.e., personal computers 41 and 42 and a server 43, have a specific E-mail address each. Any of these E-mail addresses is registered, if necessary, as destination address in the destination database.

A specific telephone number is assigned to a facsimile apparatus 54, which is an external apparatus. This telephone number is registered, if necessary, as destination telephone number in the above-mentioned destination database.

Other destinations are provided, besides the personal computers 41 and 42, the server 43 and the facsimile apparatus 54. They are a hard disk drive 25 incorporated in a main unit 1, the shared holder incorporated in the management memory 24 provided in the main unit 1, and another image forming apparatus.

The CPU 20 has the following control section (11) that performs a main function.

(11) The control section that transfers image data externally input (i.e., image data transmitted through a communications network 40 or a public telephone line 53), to a preset destination (i.e., destination registered in the destination database).

All other components of the second embodiment are identical to those of the first embodiment and will not be described in detail.

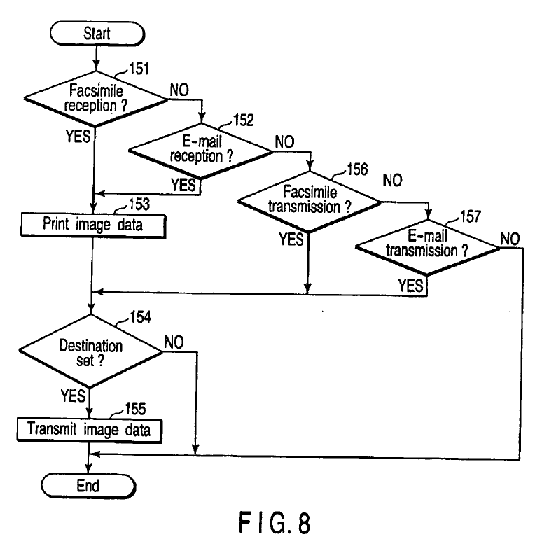

How the second embodiment operates will be explained, with reference to the flowchart of FIG. 8.

If the embodiment receives facsimile image data via the public telephone line 53 (YES in Step 151), it is printed and output (Step 153). It is then determined whether a destination has been set (Step 154). More precisely, it is determined whether the destination has been registered in the destination database.

If the destination has been set (YES in Step 154), the facsimile image data received is transferred to the destination (Step 155).

If an E-mail (with image data attached to it) is received through the communications network 40 (YES in Step 152), the image data attached to the E-mail is printed and output (Step 153). Then, it is determined whether the destination has been already set (Step 154).

If the destination has been set (YES in Step 154), the image data attached to the E-mail is transferred (Step 155).

The image received by facsimile and the E-mail received (to which image data is attached) are thus transferred to the preset destination. Hence, the document can be given to the person at the destination, fast and reliably. This prevents the missing of the document.

The facsimile apparatus 54 may perform facsimile transmission, transmitting image data to the main unit 1. In this case, the user of the facsimile apparatus 54 can confirm which image data he or she has sent, if the destination is set in the facsimile apparatus 54, i.e., the transmitting side, merely by reading the paper sheet output from the facsimile apparatus 54.

The personal computer 41 may perform E-mail transmission, sending image data to the main unit 1. In this case, the user of the personal computer 41 can confirm which image data he or she has sent, if the destination is set in the personal computer 41, i.e., the transmitting side, only by looking at the display screen of the personal computer 41.

The personal computer 41, which is an external apparatus, can utilize the facsimile transmission function or E-mail transmission function of the main unit 1. For example, the image data stored in the personal computer 41 can be transmitted to any other external apparatus via the main unit 1, by facsimile transmission or E-mail transmission. If this is the case (YES in Step 156 and YES in Step 157), it is determined whether the destination has been already set (Step 154).

If the destination has been set (YES in Step 154), the image data transmitted by facsimile transmission or E-mail transmission is transferred to the destination (Step 155).

The destination may be set in the personal computer 41 that is the transmitting side. If so, the user of the personal computer 41 can confirm which image data he or she has sent, merely by looking at the display screen of the personal computer 41.

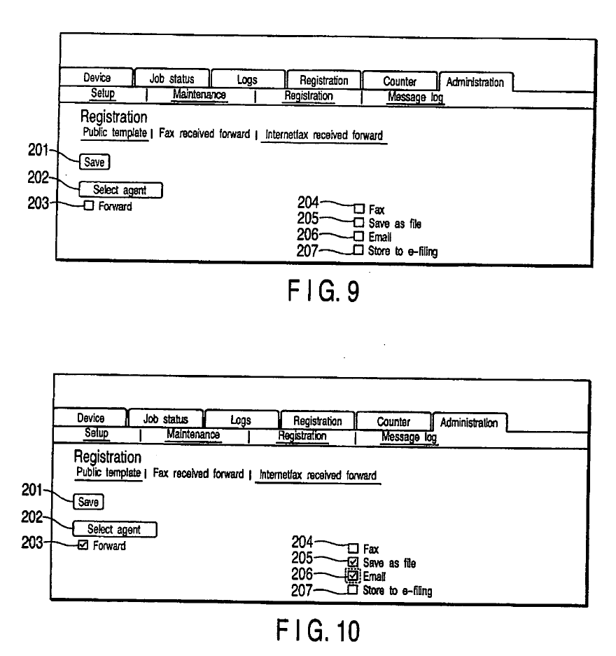

The destination can be set by using the personal computer 41, i.e., an external apparatus. How it is set will be explained with reference to FIGS. 9 to 13.

Assume that the user operates the personal computer 41, selecting the destination-setting mode. Then, the display of the personal computer 41 displays a setting menu, which is shown in FIG. 9. The setting menu has a save button 201, a select agent button 202, and check boxes 203 to 207. The check box 203 may be selected to designate data transfer. The check box 204 may be selected to designate data transfer by facsimile transmission. The check box 205 may be selected to designate data transfer to the server. The check box 206 may be selected to designate data transfer by E-mail transmission. The check box 207 may be selected to designate data transfer to the hard disc drive 25 provided in the main unit 1 or to the shared folder provided in the management memory 24.

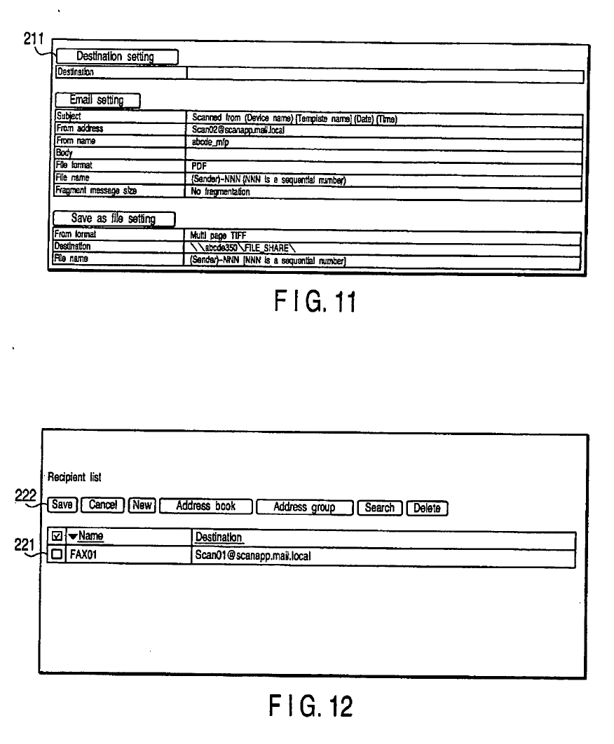

Tick marks may be input in the check boxes 203, 205 and 206 and the select agent button 202 may be turned on, as is illustrated in FIG. 10. In this case, a confirmation menu of in FIG. 11, which is concerned with the main unit 1, i.e., the transmission side, is displayed on the display of the personal computer 41. If the destination-setting button 211 in the confirmation menu is turned on, the display of the personal computer 41 will display an input menu shown in FIG. 12.

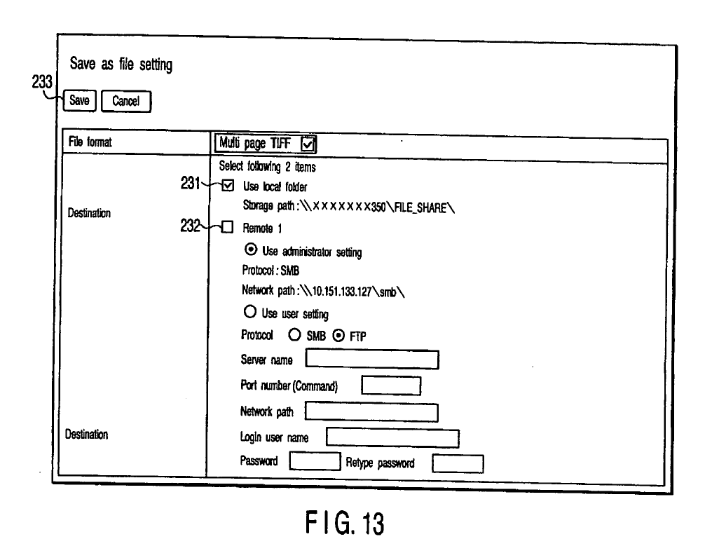

In the input menu of FIG. 12, there is displayed an input column 221 and a save button 222. The name and E-mail address of a destination can be input in the input column 221. When the save button 222 is turned on after the name and E-mail address of a destination are input, the destination is designated. When the destination is thus designated, the display of the computer 41 displays an input menu that is shown in FIG. 13.

In the input menu of FIG. 13, there are displayed check boxes 231 and 232 and a save button 233. The boxes 231 and 232 may be ticked to designate the server as destination. When the save button 233 is turned on after the check boxes 231 and 232 are ticked, the server 43 is designate as destination.

In the second embodiment, the image data received is transferred to the preset destination. Nonetheless, the image data may be transferred to a different destination, in accordance with the source from which the image data has been transmitted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a storage device for storing image data acquired by scanning a document and image data externally input;
a control section which stores one or more of image data in the storage device, without changing the format of the image data, said one or more data being those that are mainly to be printed; and
an output section which outputs each of the image data stored in the storage device.

2. The apparatus according to claim 1, wherein the image data externally input is image data sent via a communications network and a telephone line.

3. The apparatus according to claim 1, wherein the control section stores said one or more data mainly to be printed, in the storage device, without changing the format of the image data and jointly with property data relating to printing of said one or more data.

4. The apparatus according to claim 3, wherein the property data is stored in a document-print property file managed in units of documents and in a page-print property file managed in units of pages.

5. The apparatus according to claim 1, wherein the output section is at least one selected from the group consisting of a display section, a printer, a network interface and a telephone-line interface.

6. The apparatus according to claim 1, further comprising a control section which changes a format of one or more image data that are not mainly to be printed, to a prescribed versatile-image format and then stores said one or more image data in the storage device.

7. The apparatus according to claim 1, further comprising:
an editing section which edits each image data item stored in the storage device, without changing the format of the image data item; and
an output section which outputs each image data item edited by the editing section.

8. A method of controlling an image forming apparatus having a storage device for storing image data acquired by scanning a document or image data externally input, said method comprising:
storing one or more of image data in the storage device, without changing the format of the image data, said one or more data being those that are mainly to be printed; and
outputting each of the image data stored in the storage device.

9. An image forming apparatus comprising:
an output section which outputs image data acquired by scanning a document and image data externally input; and
a control section which transfers the image data externally input, to a preset destination.

10. The apparatus according to claim 9, wherein the image data externally input is image data sent via a communications network and a telephone line.

11. The apparatus according to claim 9, wherein the output section is at least one selected from the group consisting of a display section, a printer, a network interface and a telephone-line interface.

12. The apparatus according to claim 9, wherein the destination is set outside the apparatus.
